(19) United States
(12) Patent Application Publication
(10) Pub. No.: US 2026/0315311 A1
(43) Pub. Date: Oct. 15, 2026

(54) DETACHABLE PNEUMATIC THERAPEUTIC APPARATUS, AND ASSEMBLY AND DISASSEMBLY METHOD THEREOF

(71) Applicant: JKH Health Co., Ltd., Shenzhen (CN)

(72) Inventors: Quanqin DAI, Irvine, CA (US); Pu JIANG, Shenzhen (CN)

(21) Appl. No.: 19/462,811

(22) Filed: Jan. 28, 2026

Related U.S. Application Data
(63) Continuation-in-part of application No. 17/061,310, filed on Oct. 1, 2020, now Pat. No. 12,564,536.

(30) Foreign Application Priority Data
Feb. 4, 2020 (CN) 202010079478.3

(51) Int. Cl. A61H 9/00

(52) U.S. Cl. CPC A61H 9/0092; A61H 2201/0207; A61H 2201/0214; A61H 2201/025; A61H 2201/1215; A61H 2201/5007; A61H 2201/5053

(57) ABSTRACT

The present disclosure relates to a detachable pneumatic therapeutic apparatus and an assembly and disassembly method therefor. The apparatus comprises a host machine, a wrap, a pipeline component, and a detachable connection structure. The detachable connection structure includes a first connecting component arranged on the wrap and a second connecting component arranged on the host machine, wherein the first connecting component and the second connecting component are connectable and separable in a reversible manner, to enable rapid disassembly and assembly between the host machine and the wrap. Through the detachable connection structure, the present disclosure achieves convenient separation of the host machine from the wrap, which not only enhances the portability of the product and its adaptability to different treatment areas, but also allows the wrap to be independently replaced, significantly reducing the usage cost.

### CROSS REFERENCE TO RELATED APPLICATIONS

This application is a continuation-in-part of U.S. Application No. 17/061,310, filed on Oct. 1, 2020, which claims the benefit of priority to Chinese Application No. 202010079478.3, filed on Feb. 4, 2020, all of which are hereby incorporated by reference in their entireties for all purposes.

### TECHNICAL FIELD

The disclosure relates to the technical field of pneumatic therapeutic apparatuses, in particular to a detachable pneumatic therapeutic apparatus and an assembly and disassembly method.

### BACKGROUND

The air pressure therapeutic instrument mainly offers circulating pressure to limbs and other treatment areas by inflating and deflating the air bag inside the wrap worn on the treatment area. The host machine and the wrap of the existing pneumatic therapeutic apparatus are generally of a non-detachable structure: The host machine and the wrap are connected by exposed lengthy tubing, or the host machine is directly mounted and fixed on the wrap. The tubing structure presents a tripping hazard and is inconvenient to use and manage, and the fixed structure limits application range because the same wrap is difficult and even impossible to meet different treatment areas of a human body. According to different treatment areas of a human body and different heights and sizes of a human body, the needed wraps are different. Therefore, if the host machine and the wrap cannot be detachable, they can only be replaced together, which causes the use cost to be very high.

### SUMMARY

In view of the above, there is a need for a detachable pneumatic therapeutic apparatus between the host machine and the wrap with high portability and adaptability.

According to a first aspect, embodiments of the present disclosure provide a detachable pneumatic therapeutic apparatus, including: a host machine; a wrap having one or more air bags disposed inside the wrap; a pipeline component through which the host machine is in communication with the one or more air bags to control inflation and deflation of the one or more air bags; and a detachable connection structure, comprising: a first connecting component, disposed on the wrap; and a second connecting component, disposed on the host machine; wherein the first connecting component and the second connecting component are detachably connectable and separable in a reversible manner, to enable connection and detachment between the host machine and the wrap.

In accordance with the detachable pneumatic therapeutic apparatus provided in the present disclosure, the advantageous effects include the following. By providing a detachable connection structure between the wrap and the host machine, combined with the design of a modular pipeline component, users can easily assemble and disassemble the host machine and the wrap without complex operations, facilitating daily cleaning, disinfection, replacement, storage, and portability. Furthermore, a single host machine can be paired with specialized wraps designed for different body parts. Users only need to purchase different wraps to use the same host machine for therapeutic needs across multiple body areas, significantly reducing equipment purchase and storage costs while improving product utilization.

Furthermore, the detachable connection structure comprises a flexible adhesive-attachment structure, and wherein a coverage area of the first connecting component is larger than an area of the contact surface between the host machine and the wrap.

Furthermore, the first connecting component is a first hook-and-loop fastener member, disposed on the outer surface of the wrap; wherein the second connecting component is a second hook-and-loop fastener member disposed on the exterior side of the host machine; and wherein the first hook-and-loop fastener member and the second hook-and-loop fastener member provide reversible adhesive connection and separation through the engagement of hooks and loops.

Furthermore, the first connecting component is a first engagement member disposed on an outer surface of the wrap; wherein the second connecting component is a second engagement member disposed on an exterior side of the host machine; and wherein the first engagement member and the second engagement member provide reversible connection and separation by means of a snap-fit or plug-and-socket engagement.

Furthermore, the first connecting component is a first magnetic member disposed on the outer surface of the wrap; wherein the second connecting component is a second magnetic member disposed on the exterior side of the host machine; and wherein the first magnetic member and the second magnetic member provide reversible connection and separation through magnetic attraction.

Furthermore, the second connecting component is fixed to the exterior side of the host machine via a fixing assembly, and wherein the fixing assembly is detachably connected to the host machine.

Furthermore, the fixing assembly comprises a fixed frame and a connecting member, the fixed frame surrounds a bottom perimeter of the second connecting component; the connecting member sequentially passes through the fixed frame, the second connecting component, and the host machine, to secure the second connecting component between the host machine and the fixed frame; or the connecting member sequentially passes through the host machine, the second connecting component, and the fixed frame, to secure the second connecting component between the host machine and the fixed frame.

Furthermore, the one or more air bags are in communication with an inflation/deflation module inside the host machine through the pipeline component; wherein the pipeline component comprises a first connector disposed on the one or more air bags and a second connector disposed on the host machine; and wherein the first connector and the second connector are detachably mated to establish a pneumatic connection between the inflation/deflation module and the one or more air bags.

Furthermore, the pipeline component further comprises: a first air flow tubing, one end of which is connected to an air pressure nozzle of the one or more air bags, and the other end of which is connected to the first connector; and a second air flow tubing, disposed inside the host machine, one end of which is connected to the inflation/deflation module, and the other end of which is connected to the second connector; wherein the second connector is disposed on an exterior side of the host machine.

Furthermore, the inflation/deflation module comprises: an air pump, connected via the second air flow tubing to the one or more air bags for providing an inflation airflow; a first electromagnetic valve, connected to the second air flow tubing for releasing airflow; and a pressure relief valve, connected to the second air flow tubing; wherein the inflation and deflation modes for the one or more air bags are switched by controlling the opening and closing of the air pump and the first electromagnetic valve; and wherein the pressure relief valve is configured to open for pressure relief when a pressure in a pneumatic circuit exceeds a set threshold.

Furthermore, the host machine further comprises a control panel disposed inside the host machine, and both the air pump and the first electromagnetic valve are electrically connected to the control panel; wherein a pressure sensor is integrated on the control panel; and wherein the pipeline component further comprises a third air flow tubing; the pressure sensor being in communication with the second air flow tubing via the third air flow tubing.

Furthermore, the host machine further comprises one or more batteries electrically connected to the control panel, wherein the one or more batteries are rechargeable or disposable.

Furthermore, the surface of the host machine in contact with the second connecting component is configured as an arcuate contact surface having a predefined curvature, such that the host machine conforms to a treatment area.

Furthermore, the wrap is provided with a releasably mateable and adjustable fastener, such that the wrap can be worn on a treatment area.

Furthermore, the wrap further comprises a heating component disposed therein; wherein the host machine is provided with conductive contact plates, and the wrap is provided with conductive contacts; and wherein the heating component is electrically connected to the host machine through the conductive contacts and the conductive contact plates.

Furthermore, the wrap further comprises a cooling component disposed therein; wherein the host machine is provided with conductive contact plates, and the wrap is provided with conductive contacts; and wherein the cooling component is electrically connected to the host machine through the conductive contacts and the conductive contact plates.

Furthermore, the cooling component comprises a fan and a cooling plate; and wherein the fan is electrically connected to the host machine and is configured to dissipate heat from the cooling plate.

Furthermore, further comprising: a first verification module disposed on the wrap, and a second verification module disposed on the host machine; wherein after the host machine is connected to the wrap, the first verification module and the second verification module perform verification matching; and wherein the host machine controls an operational state of the host machine based on a verification matching result.

According to a second aspect, embodiments of the present disclosure provide an assembly and disassembly method for a detachable pneumatic therapeutic apparatus, comprising: aligning a second connecting component on a host machine with a first connecting component on a wrap; applying an external force to cause the first connecting component and the second connecting component to be detachably connected in a reversible manner to provide connection between the host machine and the wrap; and connecting the host machine to one or more air bags within the wrap through a pipeline component, enabling the host machine to control inflation and deflation of the one or more air bags.

In accordance with the assembly and disassembly method for a detachable pneumatic therapeutic apparatus provided in the present disclosure, the advantageous effects include the following. The method features clear steps and simple operation, enabling quick assembly of the host machine and the wrap through simple alignment and connection actions, and establishing a reliable pneumatic connection so that the apparatus can be put into use promptly. Simultaneously, based on the design of the detachable connection structure, the disassembly process is equally convenient, allowing users to perform regular or immediate cleaning, disinfection, or replacement of the wrap, thereby effectively ensuring hygiene and safety during treatment. Furthermore, the method supports the flexible combination of a single host machine with various specialized wraps. Users can quickly switch between different wraps according to varying therapeutic needs, significantly enhancing the versatility and utilization efficiency of the apparatus while reducing operational complexity and time costs for multi-site treatments.

Furthermore, further comprising: applying a pulling force in a direction perpendicular to the contact surface between the first connecting component and the second connecting component to separate the first connecting component from the second connecting component to detach the host machine from the wrap; and disconnecting the pipeline component connected between the host machine and the wrap to complete the separation of the pneumatic circuit.

In some examples, the disclosure adopts the technical scheme that: a detachable pneumatic therapeutic apparatus comprises a host machine and a wrap with the detachable connection structure on the surface of the wrap containing an air bag. The host machine can be detachably connected with the wrap through the back buckle on the surface of the wrap.

Furthermore, the wrap is equipped with the supporting bracket between the wrap and the back buckle; the supporting bracket is fixed in the wrap; the back buckle is fixed to the wrap through the supporting bracket.

Also, the host machine is detachably connected to the wrap through the back buckle.

In addition, the host machine includes an air inflation/deflation module which is connected with an inflation/deflation tubing; an inflation/deflation port connected with the inflation/deflation tubing is arranged on the housing of the host machine; a second inflation/deflation tubing connected with the air bag inside the wrap is arranged on the back buckle; the inflation/deflation tubing on the back buckle is communicated with the inflation/deflation port on the host machine in a butt joint mode to form a closed channel when

Further, the pressure sensor is equipped in the host machine and connects to another tubing and connector; the housing of the host machine has the port for the pressure sensor tubing; and the back buckle is equipped with the port that can be connected to the pressure sensor tubing connector on the host machine. When the host machine attaches to the wrap through the back buckle, the pressure detection between the host machine and wrap forms the closed passageway.

One or more batteries are in the host machine, and the battery is a disposable battery or a rechargeable battery.

The wrap includes releasably mateable and adjustable fasteners, so that the wrap can be worn on the treatment area of a human body.

The host machine can optionally be equipped with an electrically conductive contact plate to control heating and/or cooling; the wrap can optionally be equipped with the heating and/or cooling components that connect to the electrically conductive contact on the back buckle. When the host machine is detachably connected to the wrap through the back buckle, the electrically conductive contact plate will electrically connect to the heating and/or cooling components inside the wrap through the electrically conductive contact on the back buckle. Then the electrically conductive contact will generate heating and/cooling on the surface of the wrap.

The host machine can also optionally be provided with a wireless receiver.

The disclosure has the beneficial effects as follows: the host machine attaches to the wrap through the back buckle and forms detachable construction, offering the improved portability and suitability. In addition, the detachable wraps for different treatment areas can be replaced conveniently and reduce the use cost of product.

### BRIEF DESCRIPTION OF THE DRAWINGS

In order to more clearly illustrate the embodiments of the present disclosure, accompanying drawings required in the embodiments are briefly described below. It is apparent that the accompany drawings in the following description are merely some embodiments of the present disclosure. For a person of ordinary skills in the art, other drawings may also be obtained according to these drawings.

FIG. 1 is a schematic structural view of a detachable connection structure of a detachable pneumatic therapeutic apparatus according to an embodiment of the present disclosure.

FIG. 2 is an exploded view of a detachable connection structure of a detachable pneumatic therapeutic apparatus according to a first embodiment of the present disclosure.

FIG. 3 is an exploded view of a detachable connection structure of a detachable pneumatic therapeutic apparatus according to a second embodiment of the present disclosure.

FIG. 4 is an exploded view of a detachable connection structure of a detachable pneumatic therapeutic apparatus according to a third embodiment of the present disclosure.

FIG. 5 is an exploded view of a detachable connection structure of a detachable pneumatic therapeutic apparatus according to a fourth embodiment of the present disclosure.

FIG. 6 is an exploded view of a detachable connection structure of a detachable pneumatic therapeutic apparatus according to a fifth embodiment of the present disclosure.

FIG. 7 is an exploded view of a detachable connection structure of a detachable pneumatic therapeutic apparatus according to a sixth embodiment of the present disclosure.

FIG. 8 is an exploded view of a host machine of a detachable pneumatic therapeutic apparatus according to an embodiment of the present disclosure.

FIG. 9 is a schematic structural view of a wrap of a detachable pneumatic therapeutic apparatus according to an embodiment of the present disclosure.

FIG. 10 is a schematic structural view of a back buckle of a detachable pneumatic therapeutic apparatus according to an embodiment of the present disclosure.

FIG. 11 is a schematic diagram of the external structure of a detachable pneumatic therapeutic apparatus according to an embodiment of the present disclosure.

FIG. 12 is a schematic structural view of a supporting bracket of a detachable pneumatic therapeutic apparatus according to an embodiment of the present disclosure.

FIG. 13 is a schematic structural view of a back buckle of a detachable pneumatic therapeutic apparatus according to another embodiment of the present disclosure.

FIG. 14 is a schematic structural diagram illustrating an upper housing of a host machine of a detachable pneumatic therapeutic apparatus according to another embodiment of the present disclosure.

FIG. 15 is a schematic view of a detachable connection structure of a supporting bracket, a back buckle and a host machine of a detachable pneumatic therapeutic apparatus according to an embodiment of the present disclosure.

FIG. 16 is a schematic view of an internal structure of a host machine of a detachable pneumatic therapeutic apparatus according to an embodiment of the present disclosure.

FIG. 17 is a schematic structural view of a detachable pneumatic therapeutic apparatus according to a ninth embodiment of the present disclosure.

FIG. 18 is an exploded view of a detachable pneumatic therapeutic apparatus according to the ninth embodiment of the present disclosure.

FIG. 19 is a first schematic structural view of a host machine of a detachable pneumatic therapeutic apparatus according to the ninth embodiment of the present disclosure.

FIG. 20 is a second schematic structural view of a host machine of a detachable pneumatic therapeutic apparatus according to the ninth embodiment of the present disclosure.

FIG. 21 is an exploded view of a host machine of a detachable pneumatic therapeutic apparatus according to the ninth embodiment of the present disclosure.

FIG. 22 is a schematic view of an internal structure of a host machine of a detachable pneumatic therapeutic apparatus according to the ninth embodiment of the present disclosure.

FIG. 23 is an exploded view of a detachable pneumatic therapeutic apparatus according to a tenth and eleventh embodiments of the present disclosure.

### DETAILED DESCRIPTION

In order to enable the skilled person in the art to better understand technical solutions in the present disclosure, the technical solutions in the embodiments of the present disclosure will be described clearly and completely in combination with the accompanying drawings in the embodiments of the present disclosure. It is apparent that the described embodiments are only some of the embodiments, but not all the embodiments of the present disclosure. Based on the embodiments in the present disclosure, all other embodiments obtained by persons having ordinary skills in the art without creative works are within the protection scope of the present disclosure.

It should be noted that when a component is referred to as “fixed” or “placed on” another component, it is able to be directly or indirectly on the other component. When a component is referred to as “connected” to another component, it is able to be directly or indirectly connected to the other component.

In addition, the terms “first” and “second” are used for descriptive purposes only and are not to be understood as indicating or implying relative importance or as implicitly indicating the quantity of technical features indicated. Thus, a feature defined as “first” or “second” may explicitly or implicitly include one or more such features. In the description of the present disclosure, “plurality of” or “several” means two or more unless otherwise expressly specified.

It should be noted that structures, proportions, sizes, etc., depicted in the accompanying drawings are provided only to facilitate the comprehension and reading of the disclosed contents for those skilled in the art. They are not intended to limit the conditions under which the present disclosure able to be implemented and do not hold technical significance. Any modifications to the structures, changes in proportions, or adjustments in size that do not affect the effectiveness and objectives achievable by the present disclosure should still fall within the scope of the technical contents disclosed in the present disclosure. We list numbering of the components in the figures as below.

21. Wrap; 211. Inner layer; 212. Outer layer; 213. Fastener; 214. Air bag; 2141. Air pressure nozzle; 215. Heating component; 216. Cooling component; 2161. Fan; 2162. Cooling plate; 217. Conductive contact; 22. Host machine; 221. Upper housing; 2211. Display screen; 2212. Control button; 222. Lower housing; 2221. First installation hole; 223. Control panel; 2231. Pressure sensor; 224. Air pump; 225. First electromagnetic valve; 226. Second electromagnetic valve; 227. Pressure releasing valve; 228. Power port; 229. Conductive contact plate; 23. Pipeline component; 231. First connector; 232. First air flow tubing; 233. Second connector; 234. Second air flow tubing; 235. Third air flow tubing; 24. Detachable connection structure; 241. First connecting component; 242. Second connecting component; 2421. Through-hole; 243. Fixed frame; 2431. Second installation hole.

### Example One

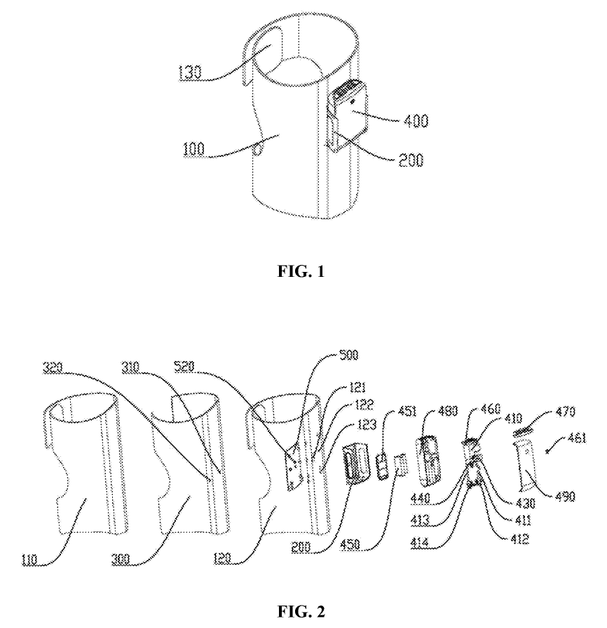

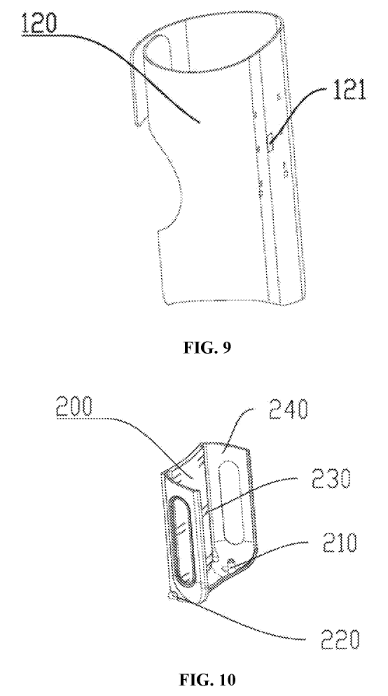

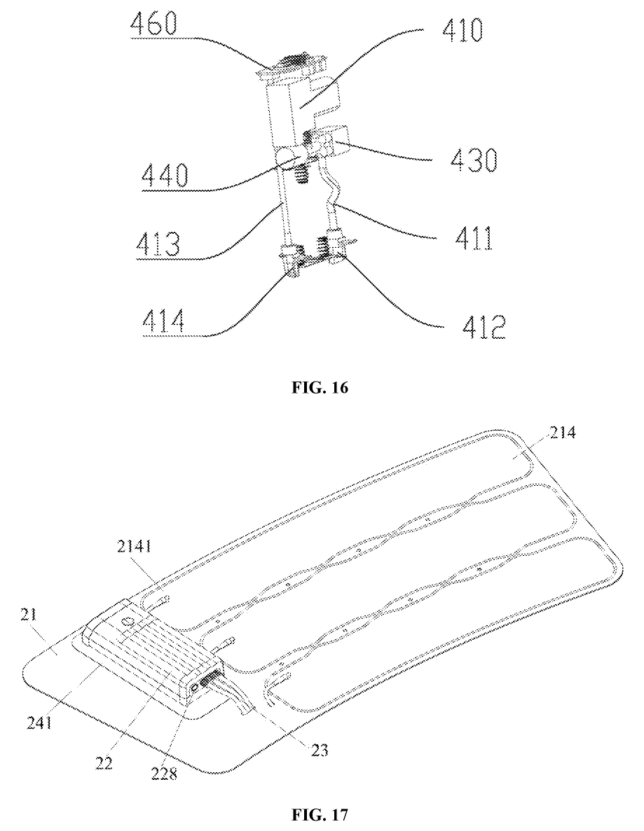

Referring to FIGS. 1-16, a detachable connection structure of a pneumatic therapeutic apparatus includes a back buckle 200 mounted on the surface of a wrap 100 containing one or more air bags 300; the host machine 400 is detachably connected with the back buckle 200 and forms an air path connection with the air bag 300 through the back buckle 200. The host machine 400 and the wrap 100 form a detachable structure through the back buckle 200, so that the portability and the adaptability of the product are improved, the wrap 100 is convenient to replace, the use cost of the product is reduced, and the service life of the product is prolonged.

Referring to FIGS. 2-7 and 15, a supporting bracket 500 is equipped between the wrap 100 and the back buckle 200, the supporting bracket 500 is fixedly connected to the wrap 100, and the back buckle 200 is fixed on the wrap 100 through the supporting bracket 500 to form an integrated wrap. Through the supporting bracket 500 is arranged, the back buckle 200 is conveniently fixed on the wrap 100, and the stability of the air tubing and/or the electric connection is improved. The supporting bracket 500 is fixedly connected with the wrap 100, and the back buckle 200 is detachably and fixedly connected with the supporting bracket 500. The back buckle 200 is provided with loop fasteners 230, the supporting bracket 500 is provided with some hook fasteners 510, and the loop fasteners 230 are matched and fixed with the hook fasteners 510. The supporting bracket 500 is provided to facilitate the installation of the back buckle 200.

The host machine 400 is connected to the components in the wrap 100 through the back buckle 200, so that the host machine 400 can control the components in the wrap 100 conveniently, and the host machine 400 can supply power to the components in the wrap 100 conveniently. Optionally, a conductive contact 420 can be arranged on the host machine 400, a port for exposing the conductive contact 520 is arranged on the back buckle 200, and the conductive contact plate 420 is electrically connected with the conductive contact 520 when the host machine 400 is attached to the back buckle 200; or, the host machine 400 is provided with the conductive contact plate 420, the supporting bracket 500 is provided with the conductive contact 520, the back buckle 200 is provided with a port for exposing the conductive contact 520, and the conductive contact plate 420 is electrically connected with the conductive contact 520 when the host machine 400 is attached to the back buckle 200. It is understood that the conductive contact 520 and the conductive contact plate 420 are connected in pairs, and each electrical connection is independently provided with at least one pair of the conductive contact 520 and the conductive contact plate 420. For example, one pair of the conductive contact 520 and the conductive contact plate 420 is provided for the electrical connection of the main machine 400 and the heating component 600, and the other pair of the conductive contact 520 and the conductive contact plate 420 is provided for the electrical connection of the host machine 400 and the cooling component 700. Generally, a control panel 460 is provided in the host machine 400, and the air inflation/deflation module 410, the battery 450, the optional heating component 600, the optional cooling component 700, the optional fan 900, and the like, are electrically connected to the control panel 460. The host machine 400 is further provided with a control button 461, and generally the control button 461 is electrically connected to the control panel 460 in a mechanical or touch contact manner.

Referring to FIGS. 2-8 and 16, an air inflation/deflation module 410 is included in the host machine 400, the air inflation/deflation module 410 is connected to an inflation/deflation tubing 411, an inflation/deflation port 412 connected to the inflation/deflation tubing 411 is arranged on a housing of the host machine 400, an air flow tubing 210 connected to the air bag 300 of the wrap 100 is arranged on the back buckle 200, and the air flow tubing 210 and the inflation/deflation port 412 are in a butt joint mode to form a closed channel when the host machine 400 is attached to the back buckle 200. The inflation/deflation tubing 411 is arranged in the host machine 400; no lengthy air tubing is between the host machine 400 and the back buckle 200, and the air connection without an external air tubing is convenient to use; in addition, the air tubing in the host machine is not easy to fall off and damage, and the safety and the reliability of the product are enhanced, resulting in a longer product life.

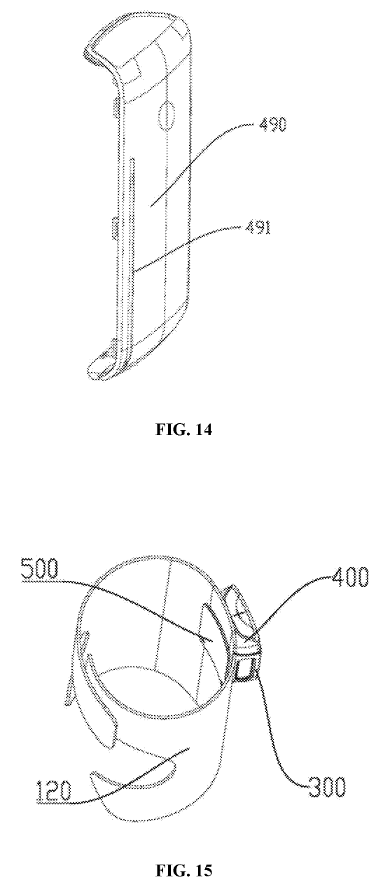

Generally, referring to FIGS. 1-8, 10-11 and 13-15, the housing of the host machine 400 includes a lower housing 480 and an upper housing 490, wherein the sliding walls 240 adapted to the shape of the lower housing 480 are arranged on both sides of the back buckle 200; the sliding walls 240 form a sliding channel, and the lower housing 480 is locked in the sliding channel. Particularly, the two sides of the lower housing 480 are arc-shaped and protrude outwards, and the arc-shaped sliding walls are clamped between the sliding walls 240 at the two sides of the back buckle 200, so that the back buckle 200 elastically clamps the lower housing 480, and the connection stability is improved. The slideway formed by the back buckle 200 is similar to a back clip of a pager, and the connection is convenient and quick. Specifically, referring to FIGS. 13 and 14, a bending convex rail 241 is connected to the sliding walls 240, and a sliding groove 491 is arranged on a surface of the upper housing 490 facing away from the back buckle 200 and adapted to the bending convex rail 241.

Or, the back buckle 200 is connected with the lower housing 480 in a buckling manner, the back buckle 200 is provided with a loop, the lower housing 480 is provided with a hook buckle matched with the loop, the detachable connection is realized through the buckling fit, the back buckle 200 can be simply provided with the hook buckle, and the lower housing 480 is provided with the loop matched with the hook buckle.

In the present invention, a pressure sensor is further provided in the host machine 400, and the pressure sensor is connected to the air bag 300 in the wrap 100 when the host machine 400 is attached to the back button 200. Referring to FIGS. 2-8 and 16, a pressure sensor is further provided in the host machine 400; a pressure detection tubing 413 connected to the pressure sensor is provided in the host machine 400; a pressure detection port 414 connected to the pressure detection tubing 413 is arranged on the housing of the host machine 400; an air pressure detection tubing 220 connected to the air bag 300 is provided on the back buckle 200; and the pressure detection port 414 and the air pressure detection tubing 220 are in a butt joint mode to form a closed channel when the host machine 400 is attached to the back buckle 200. The provision of a pressure sensor facilitates control of the air bag 300. The lower housing 480 and the upper housing 490 of the host machine 400 form an inner cavity; the lower housing 480 or the upper housing 490 is provided with a pressure detection port 414; the back buckle 200 is provided with an air pressure detection tubing 220; the pressure sensor is connected with the pressure detection port 414 through a pressure detection tubing 413; the air bag 300 is correspondingly provided with an air pressure detection nozzle 320; the air pressure detection nozzle 320 is connected with the air pressure detection tubing 220 of the back buckle 200; the pressure detection port 414 of the host machine 400 is connected to the air pressure detection tubing 220 of the back buckle 200 when the host machine 400 slides into the back buckle 200; and the pressure sensor is in a butt joint communication with the air bag 300 to form a closed channel when the host machine 400 is attached to the back buckle 200. The pressure sensors are arranged to detect the pressure of the air inflation/deflation module 410 and the pressure of the air bag 300 respectively, so that out-of-range pressure or abnormal pressure is avoided. The device can be stopped conveniently and timely, and the safety of the device is improved. Referring to FIGS. 2-14 and 16, the supporting bracket 500 is provided with an air flow tubing 530 for communicating the air pressure nozzle 310 with the air flow tubing 210; the air bag 300 in the bag body 100 is communicated with the air flow tubing 210 through the air pressure nozzle 310; and the air flow tubing 210 is communicated with an inflation/deflation tubing 411 of the host machine 400 through the inflation/deflation port 412 to form a closed air passage. the supporting bracket 500 is provided with a pressure detection connecting tubing 540 for connecting the air pressure nozzle 310 with the air pressure detection tubing 220, and the air pressure detection tubing 220 is communicated with a pressure detection tubing 413 on the host machine 400 through a pressure detection port 414.

Specifically, the back buckle 200 includes a connection panel connected to the supporting bracket 500, sliding walls 240 provided at both sides, and a bottom plate opposite to an entrance formed by the sliding walls 240. The loop fastener 230 is provided on the connection panel. The air flow tubing 210 is of an inverted L-shaped bent structure; one end of the air flow tubing protrudes from the connection panel to the wrap 100 and is in butt joint with the air pressure nozzle 310 of the air bag 300; and the other end of the air flow tubing protrudes from the bottom plate to the inlet direction and is in butt joint with the inflation/deflation port 412 of the host machine 400 to form a closed channel. The air pressure detection tubing 220 has an inverted L-shaped bent structure, one end of which protrudes from the connection panel toward the wrap 100 and is in butt joint with the air pressure detection nozzle 320 of the air bag 300; and the other end of air pressure detection tubing 220 protrudes from the bottom plate toward the inlet direction and is in butt joint with the pressure detection port 414 of the host machine 400 to form a closed channel. The conductive contact 520 on the supporting bracket 500 penetrates through the connection panel to be in contact with the conductive contact plate 420; the conductive contact plate 420 of the host machine 400 is arranged facing the connection panel; and the conductive contact 520 is generally connected with a spring and can be immersed in the connection panel; or, the conductive contact is of an inverted L-shaped bent structure, one end of the conductive contact protrudes from the connection panel to the wrap 100, the other end of the conductive contact protrudes from the bottom plate to the inlet direction and is in butt joint with the conductive contact plate 420 of the host machine 400 to form a closed channel, and the conductive contact plate of the host machine 400 is arranged facing the bottom plate.

Referring to FIGS. 2-8 and 16, the lower housing 480 and the upper housing 490 form an inner cavity, and an air inflation/deflation module 410 is provided in the inner cavity. The air inflation/deflation module 410 is connected to a control valve 430 and a pressure releasing valve 440, and the control valve 430 controls an inflation/deflation tubing 411 to control the inflation and deflation of the air bag 300. The pressure of the air bag 300 is adjusted by controlling the inflation and deflation of the air bag 300 through the control valve 430, and the control valve 430 can be a general solenoid valve; the pressure releasing valve 440 can prevent the air bag 300 from being damaged by the unrecoverable property of the air bag 300 caused by the out-of-range pressure of the air bag, so as to avoid injuring the treatment are of a human body; when the air pressure is higher than a preset threshold value, the pressure releasing valve 440 is opened to perform deflation, and the air pressure is reduced; when the air pressure is reduced to be lower than the preset threshold value, the pressure release valve 440 is closed; the effect of the pressure releasing valve 440 is to ensure that the air path from the air inflation/deflation module 410 to the air bag 300 works in a safe environment.

The host machine 400 can optionally be provided with a wireless receiver. Wireless connection is established with a remote controller or mobile communication terminal through the wireless receiver, further improving its flexibility of use and providing data display or control; general wireless communication mode can be Bluetooth or WIFI etc.

Referring to FIGS. 1-9 and 15, the wrap 100 is provided with a releasably mateable and adjustable fastener 130, so that the flexible wrap 100 is wrapped around the treatment area of a human body.

The releasably mateable and adjustable fastener 130 can be one of a hook and loop fastener, a snap fastener, a magnetic buckle, and a male and female plug. Preferably, the releasably mateable and adjustable fastener 130 is a hook and loop fastener, and the hook and loop fastener has a wide variation range and can be adapted to many treatment areas of a human body.

In a preferred embodiment of the present invention, the wrap 100 is a flexible fabric wrap, which is suitable for bending and is convenient to fit a curved surface of the treatment area. The wrap 100 comprises an inner layer 110 and an outer layer 120, wherein the inner layer 110 and the outer layer 120 are sewn or glued to enclose the air bag 300 in the cavity. Generally, the supporting bracket 500 is fixed between the outer layer 120 and the air bag 300; the hook fastener 510 on the supporting bracket 500 passes through the mounting hole 122 on the outer layer 120 to be connected with the loop fastener 230 on the back buckle 200 in a snap-fit manner; the conductive contact 520 on the supporting bracket 500 passes through the contact avoiding hole 121 on the outer layer 120 and the port on the back buckle 200 to be connected with the conductive contact plate 420 of the host machine 400; the air flow tubing 530 and the pressure detection connection tubing 540 on the supporting bracket 500 pass through the joint avoiding hole 123 on the outer layer 120 to be connected with the air flow tubing 210 on the back buckle 200, and the air flow tubing 210 is connected with the inflation/deflation tubing 411 in the host machine 400 through the inflation/deflation port 412.

In particular, the host machine 400 is optionally provided with a light/display and/or beeping reaction, so that a response prompt is given when the user operates the device.

Generally, the host machine 400 is further provided with a display screen 470, and the display screen 470 can be one of an LED screen, an OLED screen, an LCD adaptive display, or a nixie tube display. Various data are displayed through the display screen 470, and the control of an operator is facilitated.

Simply, the air bag 300 includes one or more bladder portions, each of which is typically inflated and held at a pressure point set simultaneously or independently.

The air inflation/deflation module 410 is generally an air pump, preferably an electric air pump.

### Example Two

The second embodiment is further improved and expanded on the basis of the first embodiment:
referring to FIGS. 2-8, the wrap 100 includes an inner layer 110 and an outer layer 120, the air bag 300 is wrapped between the inner layer 110 and the outer layer 120, the supporting bracket 500 is fixed on a surface of the outer layer 120 facing the air bag 300, the back buckle 200 and the supporting bracket 500 are connected to a surface of the outer layer 120 facing away from the air bag 300, the host machine 400 is detachably connected to the back buckle 200, the host machine 400 is internally provided with a battery 450, the battery 450 is one or more disposable batteries (such as AA batteries), and a lower housing 480 of the host machine is provided with a battery compartment and a battery cover 451 for opening and closing the battery compartment. The control panel 460, the air inflation/deflation module 410, the pressure sensor and the like are powered by the disposable battery, so that the portable pneumatic therapeutic apparatus is convenient to power, and convenient to carry.

### Example Three

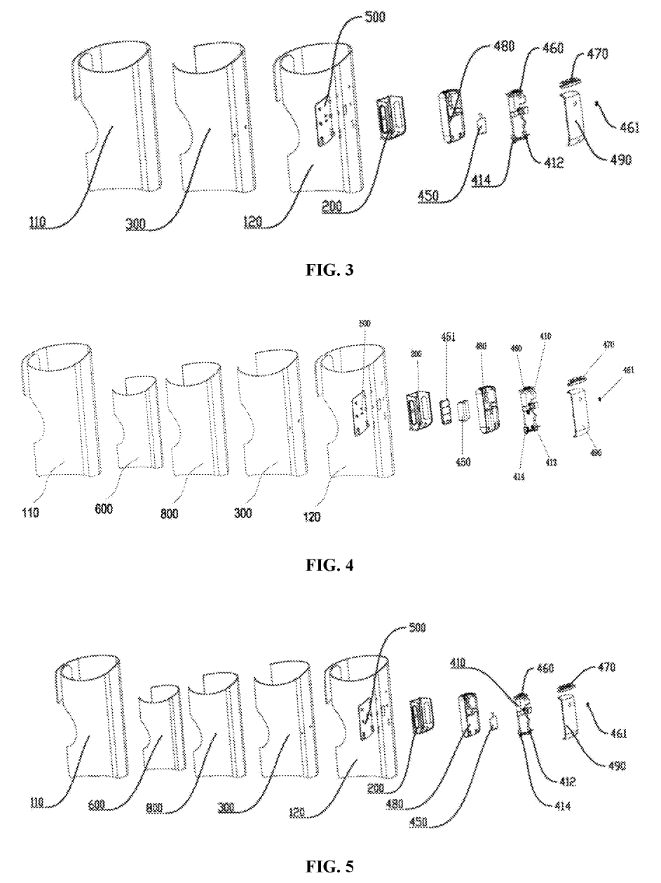

The third embodiment is an improvement and an expansion different from the second embodiment, and is different from the second embodiment in that:
referring to FIG. 3, the battery 450 in the host machine 400 is a rechargeable battery. The rechargeable battery generally employs a lithium battery or a cylindrical battery. Rechargeable battery's charging can be realized through the battery compartment and battery cover, through the power bank or other battery chargers, through the charging wire, or through the wireless charging mode.

The preferred host machine 400 is provided with a charging port on the outer housing, i.e. the lower housing 480 or the upper housing 490, and the charging port generally adopts micro-, Type-c or mini-USB interface.

### Example Four

Example 4 is a further improvement and expansion on the basis of example two:
referring to FIG. 4, one or more disposable batteries 450 are provided in the host machine 400, and a battery compartment and a battery cover 451 for opening and closing the battery compartment are provided on the lower housing 480 of the host machine 400. The host machine is provided with a conductive contact plate 420; the back buckle 200 is provided with a port for exposing the conductive contact 520; when the host machine 400 is attached to the back buckle 200, the conductive contact plate 420 is electrically connected with the conductive contact 520 in a contact manner; the wrap 100 is internally provided with a heating component 600, and the conductive contact 520 is electrically connected with the heating component 600. The heating component 600 can provide heating to improve the therapeutic effect.

The conductive contact 520 may be directly arranged on the back buckle 200 and the supporting bracket 500 may be provided with a port for electrically connecting the conductive contact 520 and the heating component 600; alternatively, the conductive contact 520 may be arranged on the supporting bracket 500 and the back buckle 200 may be provided with a port for exposing the conductive contact 520.

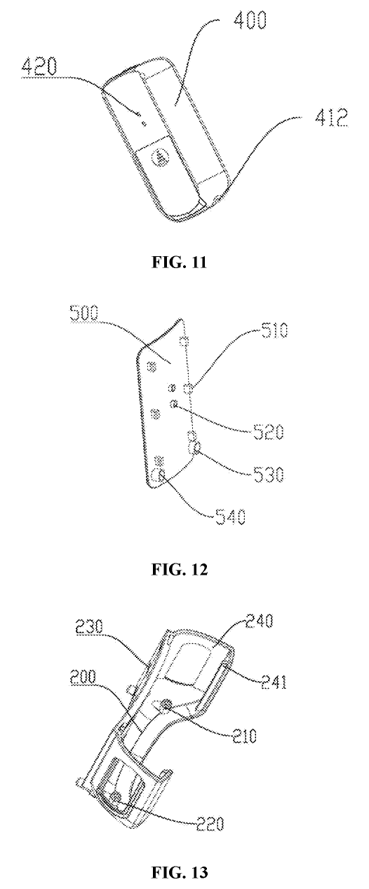

Referring to FIGS. 10-12, a conductive contact plate 420 is arranged on the host machine 400; a conductive contact 520 is arranged on the supporting bracket 500; the conductive contact 520 is electrically connected to the heating component 600; a port for exposing the conductive contact 520 is arranged on the back buckle 200; the conductive contact plate 420 is electrically connected to the conductive contact 520 when the host machine 400 is connected to the back buckle 200; the heating component 600 is arranged in the wrap 100; and the heating component 600 is connected to the conductive contact 520 through wires.

Specifically, the wrap 100 is provided therein with a separator 800, and the separator 800 is provided between the air bag 300 and the heating component 600 to separate the air bag 300 and the heating component 600. The separator 800 is provided to protect the air bag 300, so unstable air pressure caused by temperature influence on the air bag 300 is avoided.

The soft circuit board and the wire of the heating component 600 are preferably suitable for bending with strong flexibility and thin thickness. The flexible printed circuit board is generally printed on a flexible insulating substrate by using a conductive material according to a designed circuit; and the conductive material generally includes conductive metals, conductive non-metals, conductive compounds, conductive mixtures, and the like, such as conductive graphene, conductive carbon paste, silver paste, copper; and the conductive wire includes conductive cloth, conductive silica gel, conductive fiber, and the like.

### Example Five

According to an aspect of the present invention, another modification is made on the basis of the third embodiment, referring to FIG. 5, the battery 450 in the host 400 is a rechargeable battery. The difference from the third embodiment is that:

Referring to FIG. 5, the conductive contact plate 420 is arranged on the host machine 400; the back buckle 200 is arranged with a port for exposing the conductive contact 520; when the host machine 400 is attached to the back buckle 200, the conductive contact plate 420 is electrically connected to the conductive contact 520; the heating component 600 is provided in the wrap 100, and the conductive contact 520 is electrically connected to the heating component 600. The heating component 600 can provide heating function to improve the therapeutic effect.

The conductive contact 520 may be directly arranged on the back buckle 200 and the supporting bracket 500 may be provided with a port for electrically connecting the conductive contact 520 and the heating component 600; alternatively, the conductive contact 520 may be arranged on the supporting bracket 500 and the back buckle 200 may be provided with a port for exposing the conductive contact 520.

Referring to FIGS. 10-12, a conductive contact plate 420 is arranged on the host machine 400; a conductive contact 520 is arranged on the supporting bracket 500; a port for exposing the conductive contact 520 is arranged on the back buckle 200; the conductive contact 520 is electrically connected to the heating component 600; the conductive contact plate 420 is electrically connected to the conductive contact 520 when the host machine 400 is attached to the back buckle 200; the heating component 600 is arranged in the wrap 100, and the heating component 600 is connected to the conductive contact 520 through wires.

Specifically, the wrap 100 is provided therein with a separator 800, and the separator 800 is provided between the air bag 300 and the heating component 600 to separate the air bag 300 and the heating component 600. The separator 800 is provided to protect the air bag 300, so unstable air pressure caused by temperature influence on the air bag 300 is avoided.

### Example Six

The embodiment is further improved and expanded on the basis of the second embodiment, and is different from the fourth embodiment in that:

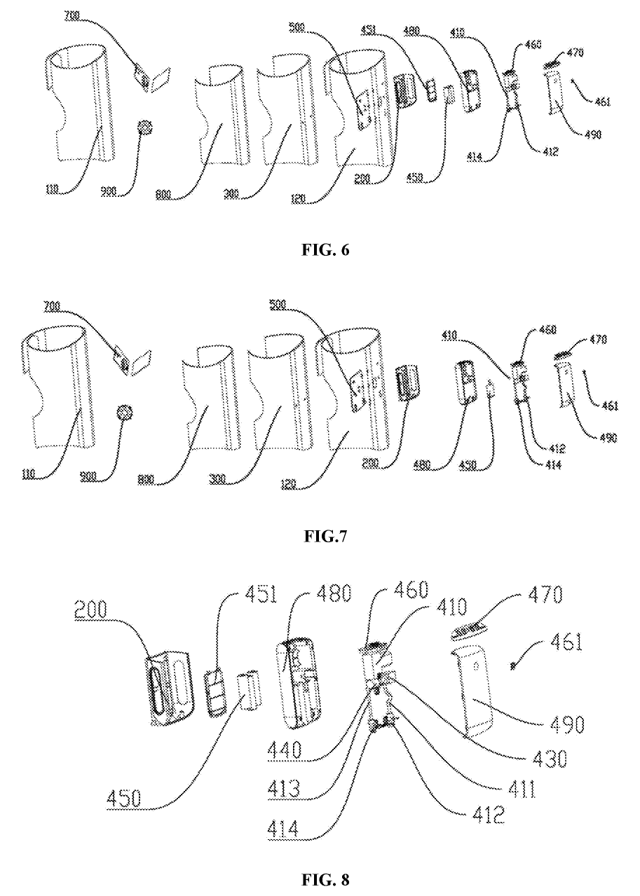

Referring to FIG. 6, one or more disposable batteries 450 are provided in the host machine 400, and a battery compartment and a battery cover 451 for opening and closing the battery compartment are arranged on the lower housing 480 of the host machine 400. The inside of the wrap 100 is provided with a cooling component 700, and the cooling component 700 is connected with a corresponding conductive contact 520 through wires. The cooling component 700 is arranged, so that a cooling function is provided for a user, and the treatment effect is improved.

The wrap 100 is provided therein with a separator 800, and the separator 800 is provided between the cooling component 700 and the air bag 300 to separate the air bag 300 and the cooling component 700. The separator 800 is arranged between the cooling component 700 and the air bag 300, so that the cooling component 700 is prevented from influencing the air bag 300, and the safe use of the air bag 300 is ensured.

Referring to FIG. 6, a fan 900 is further arranged in the wrap 100; the fan 900 discharges heat of the cooling component 700 toward the back buckle 200, and the fan 900 is connected to the conductive contact 520 through wires. The fan 900 is arranged to transfer heat generated at the back of the cooling component 700, thereby improving the cooling effect. Simply, the air bag 300 is arranged to avoid the fan 900 or the fan 900 is arranged to avoid the air bag 300; particularly, the air bag 300 is provided with a window for the fan 900 to discharge air. The cooling component 700 and the fan 900 are connected with the conductive contact 520; the conductive contact 520 is connected with the conductive contact plate 420 to form an electrical connection; and the cooling component 700 and the fan 900 are generally connected with the same conductive contact 520, or can be respectively connected with the individual conductive contact 520 according to requirements.

The conductive contact 520 may be directly arranged on the back buckle 200 and the supporting bracket 500 may be provided with a port for electrically connecting the conductive contact 520 with the cooling component 700 and the fan 900; alternatively, the conductive contact 520 may be arranged on the supporting bracket 500 and the back buckle 200 may be provided with a port for exposing the conductive contact 520.

Referring to FIGS. 10-12, a conductive contact plate 420 is arranged on the host machine 400; a conductive contact 520 is arranged on the supporting bracket 500; a port for exposing the conductive contact 520 is arranged on the back buckle 200; the conductive contact 520 is electrically connected to the cooling component 700 and the fan 900; the conductive contact plate 420 is electrically connected to the conductive contact 520 when the host machine 400 is connected to the back buckle 200; the cooling component 700 and the fan 900 are arranged in the wrap 100, and the cooling component 700 and the fan 900 are connected to the conductive contact 520 through wires.

The cooling component 700 is generally a semiconductor refrigerating sheet, the refrigerating surface and the heat dissipating surface of which faces the inner layer 110 and the outer layer 120, respectively; and the fan 900 is arranged on the heat dissipating surface of the semiconductor refrigerating sheet.

### Example Seven

The embodiment is further improved and expanded based on the third embodiment. Please refer to FIG. 7, the battery 450 in the host machine 400 is a rechargeable battery. And difference from example five is as follows:

Referring to FIG. 7, the inside of the wrap 100 is provided with a cooling component 700, and the cooling component 700 is connected to the corresponding conductive contact 520 through wires. The cooling component 700 is arranged, so that a cooling function is provided for a user, and the treatment effect is improved.

The wrap 100 is provided therein with a separator 800, and the separator 800 is provided between the cooling component 700 and the air bag 300 to separate the air bag 300 and the cooling component 700. The separator 800 is arranged between the cooling component 700 and the air bag 300, so that the cooling component 700 is prevented from influencing the air bag 300, and the safe use of the air bag 300 is ensured.

Referring to FIG. 7, a fan 900 is further arranged in the wrap 100; the fan 900 discharges heat of the cooling component 700 toward the back buckle 200, and the fan 900 is connected to the conductive contact 520 through wires. The fan 900 is arranged to transfer heat generated at the back of the cooling component 700, thereby improving the cooling effect. Simply, the air bag 300 is arranged to avoid the fan 900 or the fan 900 is arranged to avoid the air bag 300; particularly, the air bag 300 is provided with a window for the fan 900 to discharge air. The cooling component 700 and the fan 900 are connected with the conductive contact 520; the conductive contact 520 is connected with the conductive contact plate 420 to form an electrical connection; and the cooling component 700 and the fan 900 are generally connected with the same conductive contact 520, or can be respectively connected with the individual conductive contact 520 according to requirements.

### Example Eight

Embodiment eight is an improvement and extension made according to another aspect of the invention:

The host machine 400 is provided with a conductive contact plate 420; the supporting bracket 500 is provided with a conductive contact 520; the back buckle 200 is provided with a port for exposing the conductive contact 520; the host machine 400 is electrically connected with the conductive contact 520 in a contact manner when being connected; the wrap 100 is internally provided with a heating component 600 and a cooling component 700, and the heating component 600 and the cooling component 700 are connected with the conductive contact 520 through wires. Meanwhile, the heating component 600 and the cooling component 700 are arranged in the wrap 100, and the heating or cooling feature can be selected according to needs, so that more choices are provided, and the application is enhanced.

The wrap 100 is internally provided with a separator 800; the air bag 300, the separator 800, the heating component 600, and the cooling component 700 are sequentially stacked.

The inside of the wrap 100 is provided with the cooling component 700; the inside of the wrap 100 is also provided with the fan 900; the fan 900 discharges the heat of the cooling component 700 towards the direction of the back buckle 200, and the fan 900 is connected with the conductive contact 520 through wires.

That is, the conductive contacts 520 and the conductive contact plates 420 are provided in two pairs: one pair makes the control board 460 of the host machine 400 be in electrical contact with the heat component 600 in the wrap 100, and the other pair makes the control board 460 of the host machine 400 be in electrical contact with the cooling component 700 and the fan 900 in the wrap 100. The battery 450 is electrically connected with the control board 460 to supply power to other components such as the two conductive contact plates 420, the control valve 430, the pressure releasing valve 440, the pressure sensor, and the display screen 470.

In conclusion, according to the detachable connection structure for the pneumatic therapeutic apparatus provided by the invention, the host machine and the wrap are simply and quickly attached and detached, so that the use convenience, portability and adaptability of the product are improved, the wrap is convenient to replace, the use cost of the product is reduced, and the service life of the product is prolonged.

### Example Nine

Referring to FIGS. 17-23, a detachable pneumatic therapeutic apparatus, comprising: a host machine 22; a wrap 21, having one or more air bags 214 disposed inside; a pipeline component 23, through which the host machine 22 is in communication with the one or more air bags 214 to control inflation and deflation of the air bags 214; and a detachable connection structure 24, comprising: a first connecting component 241, disposed on the wrap 21; a second connecting component 242, disposed on the host machine 22; wherein the first connecting component 241 and the second connecting component 242 are detachably connectable and separable in a reversible manner, thereby enabling connection and detachment between the host machine 22 and the wrap 21.

In accordance with the detachable pneumatic therapeutic apparatus provided in the present disclosure, the advantageous effects include the following. By providing a detachable connection structure 24 between the wrap 21 and the host machine 22, combined with the design of a modular pipeline component 23, users can easily assemble and disassemble the host machine 22 and the wrap 21 without complex operations, facilitating daily cleaning, disinfection, replacement, storage, and portability. Furthermore, a single host machine 22 can be paired with specialized wraps 21 designed for different body parts. Users only need to purchase different wraps 21 to use the same host machine 22 for therapeutic needs across multiple body areas, significantly reducing equipment purchase and storage costs while improving product utilization.

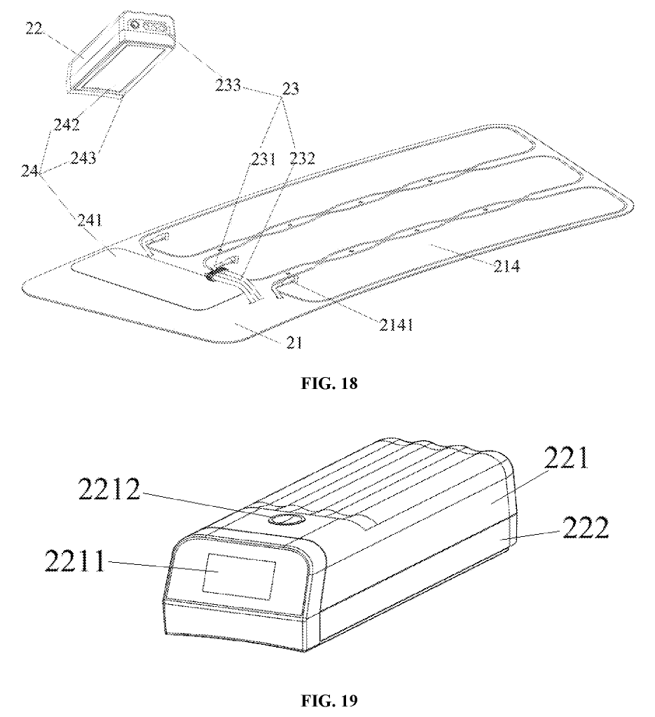

Referring to FIGS. 17 and 18, the detachable connection structure 24 is a flexible adhesive-attachment structure; wherein the coverage area of the first connecting component 241 is larger than the area of the contact surface between the host machine 22 and the wrap 21.

Specifically, the host machine 22 can be securely attached simply by placing its second connecting component 242 at any location within the large-area region of the first connecting component 241 on the wrap 21 and pressing down. This design significantly reduces operational difficulty, allowing users to quickly and effortlessly secure the host machine 22. It is particularly suitable for operations on curved body surfaces or in scenarios with limited visual guidance. Additionally, the large-area flexible adhesive attachment enhances the adaptability of the connection structure to complex surfaces, improving the reliability of the connection.

Referring to FIGS. 17 and 18, the first connecting component 241 is a first hook-and-loop fastener member, disposed on the outer surface of the wrap 21; the second connecting component 242 is a second hook-and-loop fastener member, disposed on the exterior side of the host machine 22; and the first hook-and-loop fastener member and the second hook-and-loop fastener member achieve reversible adhesive connection and separation through the engagement of hooks and loops.

Specifically, the first hook-and-loop fastener member is preferably a relatively large-area loop tape (or pile tape), which is sewn or heat-pressed onto the outer surface of the wrap 21. The second hook-and-loop fastener member is a hook tape that matches the loop tape, and it is attached to the host machine 22 by means of adhesion, screw fastening, or insert molding. The hook tape structure is typically made of relatively tough plastic material, offering greater wear resistance and peel strength, resulting in a relatively longer service life; by arranging the hook tape structure on the host machine 22—which serves as the core component and is expected to have a longer operational lifespan—the long-term reliability of the fixed connection structure is ensured. The loop tape structure, during repeated peeling cycles, is more prone to wear of its pile fibers, leading to a gradual decline in adhesion strength and a relatively shorter service life. Since the wrap 21 itself is a component that directly contacts the user's body, may require frequent cleaning, and is subject to aging and replacement with use—thus falling under the category of an expected consumable—placing the loop tape structure on the wrap 21 allows it to be discarded and replaced together with the entire wrap 21, offering simple operation and controllable costs.

When connection is required, the user only needs to align the hook tape area of the host machine 22 with the loop tape area of the wrap 21 and press down; the two then engage over a large area through the fine hook structures and loop piles, generating a reliable adhesive force. For detachment, a force applied perpendicular to the contact surface is sufficient to separate the two. This solution offers the advantages of rapid connection, large contact area, and tolerance for positional inaccuracies.

Referring to FIGS. 18-21, the second connecting component 242 is fixed to the exterior side of the host machine 22 via a fixing assembly; and the fixing assembly is detachably connected to the host machine 22.

Specifically, the fixing assembly may employ one or a combination of a clamping structure, a snap-fit structure, or an adsorption structure to achieve its detachable fixing function. The clamping structure includes a pressure plate or a pressure frame, which is fixed to the exterior side of the host machine 22 via connectors such as screws or bolts, thereby clamping and securing the second connecting component 242 between the host machine 22 and the pressure plate. The snap-fit structure includes a base attached to the back side of the second connecting component 242. This base is provided with hooks, elastic snap arms, or slots, while corresponding positions on the host machine 22 are provided with matching slots, protrusions, or ledges. The detachable connection between the fixing assembly (together with the second connecting component 242) and the host machine 22 is achieved through snap-fit engagement. The adsorption structure includes a magnetic plate or an iron plate attached to the back side of the second connecting component 242, while corresponding positions on the host machine 22 are provided with an iron plate or a magnetic plate for mutual adsorption. The detachable connection between the fixing assembly (together with the second connecting component 242) and the host machine 22 is realized through magnetic attraction.

Referring to FIGS. 18-21, the fixing assembly comprises a fixed frame 243 and a connecting member; wherein the fixed frame 243 surrounds the bottom perimeter of the second connecting component 242; the connecting member sequentially passes through the fixed frame 243, the second connecting component 242, and the host machine 22, thereby securing the second connecting component 242 between the host machine 22 and the fixed frame 243; or the connecting member sequentially passes through the host machine 22, the second connecting component 242, and the fixed frame 243, thereby securing the second connecting component 242 between the host machine 22 and the fixed frame 243.

Specifically, the exterior side of the host machine 22 is provided with a plurality of first installation holes 2221 arranged in an annular array, which are preferably threaded holes or through holes. The fixed frame 243 is an annular border structure that matches the contour of the second connecting component 242, and second installation holes 2431 are provided at positions on the fixed frame 243 corresponding to the first installation holes 2221. These second installation holes 2431 are preferably countersunk holes or through holes. The second connecting component 242 is provided with through-holes 2421 at positions corresponding to each of the first installation holes 2221.

During assembly, the second connecting component 242 is placed on the host machine 22 with its bonding surface facing outward, and all through-holes 2421 are aligned with the corresponding first installation holes 2221. Subsequently, the fixed frame 243 is placed over the second connecting component 242, ensuring that its second installation holes 2431 are coaxially aligned with the through-holes 2421 and the first installation holes 2221. Finally, a plurality of connecting members (such as set screws, bolts, or rivets) are sequentially passed through the second installation holes 2431, the through-holes 2421, and the first installation holes 2221—or sequentially through the first installation holes 2221, the through-holes 2421, and the second installation holes 2431—to secure the second connecting component 242 to the exterior side of the host machine 22. As a result, the second connecting component 242 is firmly clamped between the host machine 22 and the fixed frame 243, with its working surface fully exposed to ensure reliable connection with the first connecting component 241 on the wrap 21.

Referring to FIGS. 17 and 18, the air bag 214 is in communication with an inflation/deflation module inside the host machine 22 through the pipeline component 23; the pipeline component 23 comprises a first connector 231 disposed on the air bag 214 and a second connector 233 disposed on the host machine 22; and the first connector 231 and the second connector 233 are detachably mated to establish a pneumatic connection between the inflation/deflation module and the air bag 214.

Specifically, when use is required, aligning and engaging the first connector 231 with the second connector 233 establishes a sealed pneumatic path from the inflation/deflation module inside the host machine 22 to the air bag 214. When it is necessary to separate the host machine 22 from the air bag 214, simply pulling them apart disconnects the pneumatic path, making the operation highly convenient.

In one embodiment, the first connector 231 and second connector 233 may adopt a quick-connect pneumatic coupling. For example, the second connector 233 is a female connector with a self-locking groove, while the first connector 231 is a male connector equipped with a sealing ring and a snap ring. During connection, the male connector is inserted into the female connector until the snap ring engages with the locking groove, simultaneously ensuring an airtight seal via the sealing ring. For detachment, pressing the release ring on the female connector allows the male connector to be easily withdrawn. In another embodiment, the first connector 231 and second connector 233 may also employ a magnetically-attached sealed coupling. For example, the end faces of the first connector 231 and second connector 233 are respectively embedded with magnetic rings of opposite polarity, and the end faces are provided with sealing rings. When the two interfaces are brought close, magnetic force automatically attracts and aligns them, compressing the sealing rings to form a sealed pneumatic path. For detachment, simply applying a pulling force sufficient to overcome the magnetic attraction separates the connectors.

Referring to FIGS. 17, 18 and 22, the pipeline component 23 further comprises: a first air flow tubing 232, one end of which is connected to the air pressure nozzle 2141 of the air bag 214, and the other end of which is connected to the first connector 231; a second air flow tubing 234, disposed inside the host machine 22, one end of which is connected to the inflation/deflation module, and the other end of which is connected to the second connector 233; wherein the second connector 233 is disposed on the exterior side of the host machine 22.

Specifically, the wrap 21 (including the air bag 214, the first air flow tubing 232, and the first connector 231) can function as an independent consumable or component, achieving plug-and-play functionality with the host machine 22 (including the inflation/deflation module, the second air flow tubing 234, and the second connector 233). Through the standardized design of the pneumatic interface, the connection between the wrap 21 and the host machine 22 is made reliable. This not only significantly enhances user convenience—facilitating the replacement, cleaning, or selection of wraps 21 with different specifications—but also ensures the airtightness and stability of the pneumatic connection during treatment.

More specifically, the first air flow tubing 232 may be connected to a single air bag 214 to achieve one-to-one inflation/deflation; alternatively, the first air flow tubing 232 may be connected to multiple air bags 214 to achieve one-to-many inflation/deflation.

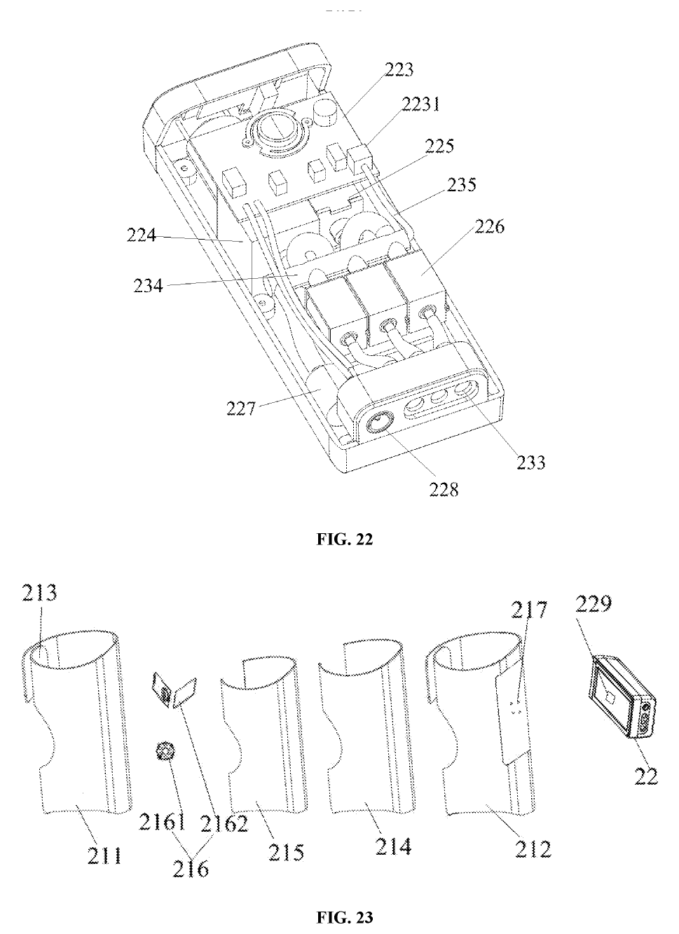

Referring to FIG. 22, the inflation/deflation module comprises: an air pump 224, connected via the second air flow tubing 234 to one or more of the air bags 214 for providing inflation airflow; a first electromagnetic valve 225, connected to the second air flow tubing 234 for releasing airflow; a pressure relief valve 227, connected to the second air flow tubing 234; wherein the inflation and deflation modes for the air bag(s) 214 are switched by controlling the opening and closing of the air pump 224 and the first electromagnetic valve 225; and the pressure relief valve 227 is configured to open for pressure relief when the pneumatic circuit pressure exceeds a set threshold.

Specifically, if there are multiple air bags 214, it further includes second electromagnetic valves 226 equal in number to the air bags 214. Each second electromagnetic valve 226 is installed on an independent air path between the air pump 224 and a corresponding air bag 214. By independently controlling the opening and closing of each second electromagnetic valve 226, the air pump 224 can achieve independent and selective inflation and pressure maintenance for multiple air bags 214. This pipeline design enables precise pressure treatment for specific body parts, avoiding pressure on unrelated areas, thereby enhancing comfort and therapeutic efficacy. It offers flexible and diverse operation modes, providing a hardware foundation for implementing complex pressure cycle patterns (such as wave, intermittent, or gradient patterns), thereby enriching the functionality of the therapeutic apparatus.

Referring to FIG. 22, the host machine 22 is further provided with a control panel 223 disposed inside it, and both the air pump 224 and the first electromagnetic valve 225 are electrically connected to the control panel 223; a pressure sensor 2231 is integrated on the control panel 223; and the pipeline component 23 further comprises a third air flow tubing 235; the pressure sensor 2231 is in communication with the second air flow tubing 234 via the third air flow tubing 235.

Specifically, the pressure sensor 2231 is used to monitor the pressure between the inflation/deflation module and the air bag 214. If the pressure exceeds the allowable range or is abnormal, the device can be promptly stopped, thereby enhancing operational safety.

More specifically, the housing of the host machine 22 comprises an upper housing 221 and a lower housing 222, which are joined together by at least one of snap-fit connection, threaded connection, adhesion, or welding. Components such as the control panel 223, air pump 224, and first electromagnetic valve 225 are all housed within the cavity formed by the upper housing 221 and lower housing 222.

Furthermore, the exterior side of the host machine 22 is also provided with a power port 228, which is electrically connected to the control panel 223 and can supply power to it. The upper housing 221 is equipped with a display screen 2211 and control buttons 2212, both of which are electrically connected to the control panel 223.

The host machine 22 further comprises one or more batteries electrically connected to the control panel 223, wherein the one or more batteries are rechargeable or disposable.

Specifically, the battery may be a rechargeable battery. The host machine 22 is correspondingly provided with a battery compartment or a dedicated battery mounting bracket, and the battery is reliably electrically connected to the battery management unit on the control panel 223 via contact points or connectors. Alternatively, the battery may be a disposable battery. The battery compartment can be designed to be compatible with standard specifications (e.g., AA, AAA) of disposable dry cells, which connect to the control panel 223 via spring contacts. This configuration is suitable for specific backup or low-cost scenarios.

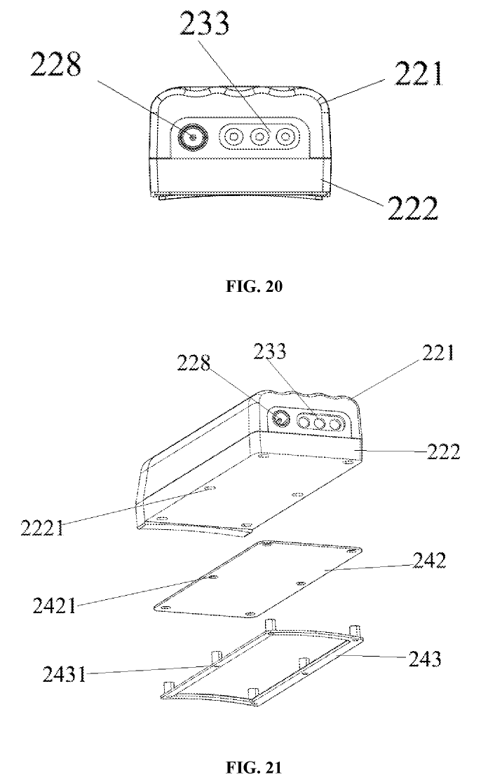

Referring to FIGS. 19 and 20, the surface of the host machine 22 in contact with the second connecting component 242 is configured as an arcuate contact surface with a predefined curvature, such that the host machine 22 conforms to the treatment area.

Specifically, the second connecting component 242 may be disposed on the external bottom of the host machine 22, meaning the external bottom of the host machine 22 is configured as the arcuate contact surface. This arcuate contact surface is designed based on ergonomic principles to closely and stably conform to the natural contours of human limbs, thereby enhancing wearing comfort and the stability of the host machine 22 during therapy. Building on this, the present invention provides a series of interchangeable specialized air bag wraps to achieve targeted treatment for different body parts. The main types of wraps include: Lower Limb Treatment Series: such as thigh sleeves conforming to the thigh, and calf wraps covering from the calf to the ankle. Joint Treatment Series: such as knee wraps encircling the knee joint, and elbow wraps covering the elbow joint. Upper Limb Treatment Series: such as upper arm wraps for the upper arm/shoulder, and forearm wraps covering the forearm and hand. Torso Treatment Series: such as lumbar wraps for lumbar support and compression.

Referring to FIG. 23, the wrap 21 is provided with a releasably mateable and adjustable fastener 213, such that the wrap 21 can be worn on the treatment area.

Specifically, the fastener 213 is designed to enable one-step wearing, stepless adjustment, and broad compatibility with different body types. This ensures treatment stability and user comfort, while simplifying operation.

Referring to FIGS. 17-23, an assembly and disassembly method for a detachable pneumatic therapeutic apparatus, the assembly method comprises: aligning a second connecting component 242 on a host machine 22 with a first connecting component 241 on a wrap 21; applying an external force to cause the first connecting component 241 and the second connecting component 242 to be detachably connected in a reversible manner, thereby achieving connection between the host machine 22 and the wrap 21; and connecting the host machine 22 to one or more air bags 214 within the wrap 21 through a pipeline component 23, enabling the host machine 22 to control inflation and deflation of the air bags 214.

In accordance with the assembly and disassembly method for a detachable pneumatic therapeutic apparatus provided in the present disclosure, the advantageous effects include the following. The method features clear steps and simple operation, enabling quick assembly of the host machine 22 and the wrap 21 through simple alignment and connection actions, and establishing a reliable pneumatic connection so that the apparatus can be put into use promptly. Simultaneously, based on the design of the detachable connection structure 24, the disassembly process is equally convenient, allowing users to perform regular or immediate cleaning, disinfection, or replacement of the wrap 21, thereby effectively ensuring hygiene and safety during treatment. Furthermore, the method supports the flexible combination of a single host machine 22 with various specialized wraps 21. Users can quickly switch between different wraps 21 according to varying therapeutic needs, significantly enhancing the versatility and utilization efficiency of the apparatus while reducing operational complexity and time costs for multi-site treatments.

Referring to FIGS. 17 and 18, the disassembly method comprises: applying a pulling force in a direction perpendicular to the contact surface between the first connecting component 241 and the second connecting component 242 to separate the first connecting component 241 from the second connecting component 242, thereby detaching the host machine 22 from the wrap 21; and disconnecting the pipeline component 23 connected between the host machine 22 and the wrap 21 to complete the separation of the pneumatic circuit.

Specifically, the first connecting component 241 and the second connecting component 242 are connected through mutual engagement. When disassembly is required, the user can pull the host machine 22 outward in a direction perpendicular to the contact surface between the two, causing the first connecting component 241 and the second connecting component 242 to separate. Subsequently, the first connector 231 and the second connector 233 of the pipeline component 23 are separated to complete the disconnection of the pneumatic circuit. This process requires no tools, is simple and quick to operate, and facilitates daily maintenance.

### Example Ten

The tenth embodiment is further improved and expanded on the basis of the ninth embodiment: referring to FIG. 23, the wrap 21 further comprises a heating component 215 disposed therein; the host machine 22 is provided with conductive contact plates 229, and the wrap 21 is provided with conductive contacts 217; the heating component 215 is electrically connected to the host machine 22 through the conductive contacts 217 and the conductive contact plates 229.

Specifically, the wrap 21 comprises, sequentially from the outside to the inside, an outer layer 212, an air bag 214, a heating component 215, and an inner layer 211. The conductive contact plates 229 are disposed on the contact surface between the host machine 22 and the second connecting component 242, and are exposed on the outer side through clearance holes in the second connecting component 242. The conductive contacts 217 are disposed on the contact surface between the outer layer 212 of the wrap 21 and the first connecting component 241, and are exposed on the outer side through clearance holes in the first connecting component 241. The conductive contact plates 229 and the conductive contacts 217 make contact to establish an electrical connection between the heating component 215 and the control panel 223.

### Example Eleven

The eleventh embodiment is further improved and expanded on the basis of the ninth embodiment: referring to FIG. 23, the wrap 21 further comprises a cooling component 216 disposed therein; the host machine 22 is provided with conductive contact plates 229, and the wrap 21 is provided with conductive contacts 217; the cooling component 216 is electrically connected to the host machine 22 through the conductive contacts 217 and the conductive contact plates 229.

Specifically, the wrap 21 comprises, sequentially from the outside to the inside, an outer layer 212, an air bag 214, a cooling component 216, and an inner layer 211. The conductive contact plates 229 are disposed on the contact surface between the host machine 22 and the second connecting component 242, and are exposed on the outer side through clearance holes in the second connecting component 242. The conductive contacts 217 are disposed on the contact surface between the outer layer 212 of the wrap 21 and the first connecting component 241, and are exposed on the outer side through clearance holes in the first connecting component 241. The conductive contact plates 229 and the conductive contacts 217 make contact to establish an electrical connection between the cooling component 216 and the control panel 223.

The cooling component 216 comprises a fan 2161 and a cooling plate 2162; wherein the fan 2161 is electrically connected to the host machine 22 and is configured to dissipate heat from the cooling plate 2162.

Specifically, the fan 2161 exhausts heat from the cooling plate 2162 towards the outer layer 212 of the wrap 21.

### Example Twelve

The twelfth embodiment is further improved and expanded on the basis of the ninth embodiment: further comprising: a first verification module disposed on the wrap 21, and a second verification module disposed on the host machine 22; after the host machine 22 is connected to the wrap 21, the first verification module and the second verification module perform verification matching; and the host machine 22 controls its operational state based on the verification matching result.

Specifically, the verification method may comprise one or a combination of the following:1. Electrical verification: The first verification module includes a resistor, capacitor, or encoding circuit with a predefined electrical value; the second verification module includes a corresponding detection circuit. The host machine 22 can read the electrical parameter via the conductive contact plates 229 and the conductive contacts 217 to identify the type or specification of the wrap 21. 2. Communication verification: The first verification module is a Near Field Communication (NFC) tag, a Radio Frequency Identification (RFID) tag, or a Bluetooth Low Energy (BLE) module, storing identity information of the wrap 21; the second verification module is a corresponding reader/writer or communication module for acquiring and verifying the identity information. 3. Mechanical/Physical verification: Specific guiding structures or keyway structures are provided between the first connector 231 and the second connector 233 of the pipeline component 23, or between the first connecting component 241 on the wrap 21 and the second connecting component 242 on the host machine 22, to achieve physical matching, thereby allowing only structurally compatible wraps 21 to connect. 4. Optical verification: The first verification module is a predefined color block, QR code, or barcode; the second verification module includes an optical sensor or camera for recognizing the optical feature.

### Example Thirteen

The thirteenth embodiment is an improvement and an expansion different from the ninth embodiment, and is different from the ninth embodiment in that: referring to FIGS. 17 and 18, the first connecting component 241 is a first engagement member, disposed on the outer surface of the wrap 21; the second connecting component 242 is a second engagement member, disposed on the exterior side of the host machine 22; and the first engagement member and the second engagement members achieve reversible connection and separation by means of a snap-fit or plug-and-socket engagement.

Specifically, the first engagement member and the second engagement member constitute a mechanical interlocking system. In one embodiment, the first engagement member comprises a plurality of hooks or male snap-fit connectors uniformly distributed on a connection plate located on the outer surface of the wrap 21; the second engagement member comprises slots or female snap-fit receptacles correspondingly positioned on the host machine 22 to align with the hooks. During connection, the host machine 22 is aligned with the wrap 21 and pressed downward, causing the hooks to elastically deform and subsequently engage and lock into the slots. For detachment, it is typically necessary to operate a release mechanism (such as pressing an unlock button) to disengage the hooks. In another embodiment, a plug-and-socket quick-release connector may be employed. For example, the wrap 21 may be provided with a stud featuring external threads (serving as the first engagement member), while the host machine 22 is equipped with a knob featuring internal threads (serving as the second engagement member); connection and locking are achieved through rotation. This solution offers the advantages of secure connection, clear tactile feedback, and strong shear resistance.

### Example Fourteen

The fourteenth embodiment is an improvement and an expansion different from the ninth embodiment, and is different from the ninth embodiment in that: referring to FIGS. 17 and 18, the first connecting component 241 is a first magnetic member, disposed on the outer surface of the wrap 21; the second connecting component 242 is a second magnetic member, disposed on the exterior side of the host machine 22; and the first magnetic member and the second magnetic members achieve reversible connection and separation through magnetic attraction.

Specifically, the first and second magnetic members are paired permanent magnets, or a combination of a permanent magnet and a magnetically permeable plate (such as a low-carbon steel plate). For example, multiple neodymium iron boron magnets are embedded in a matrix pattern on the outer surface of the wrap 21 to serve as the first magnetic member; an equal number of magnetically permeable steel plates or magnets with opposite polarity are correspondingly embedded in the host machine 22 to serve as the second magnetic member. When the two are brought within a certain distance, magnetic force causes them to automatically align and snap together. This solution offers the advantages of requiring no precise alignment and enabling extremely convenient connection and separation operations, making it particularly suitable for scenarios requiring frequent assembly and disassembly, or for users with limited hand dexterity.

The description of the embodiments described above enables those skilled in the art to implement or use the present disclosure. Various modifications to these embodiments will be apparent to those skilled in the art, and general principles defined herein may be implemented in other embodiments without departing from the spirit or scope of the present disclosure. Therefore, the present disclosure is not limited to the embodiments described herein but is to be accorded the widest scope consistent with the principles and novel features disclosed herein.

What is claimed is:

1. A detachable pneumatic therapeutic apparatus, comprising:
a host machine;
a wrap having one or more air bags disposed inside the wrap;
a pipeline component through which the host machine is in communication with the one or more air bags to control inflation and deflation of the one or more air bags; and
a detachable connection structure, comprising:
a first connecting component, disposed on the wrap; and
a second connecting component, disposed on the host machine,
wherein the first connecting component and the second connecting component are detachably connectable and separable in a reversible manner to enable connection and detachment between the host machine and the wrap.

2. The detachable pneumatic therapeutic apparatus according to claim 1, wherein the detachable connection structure comprises a flexible adhesive-attachment structure, and wherein a coverage area of the first connecting component is larger than an area of the contact surface between the host machine and the wrap.

3. The detachable pneumatic therapeutic apparatus according to claim 1, wherein the first connecting component is a first hook-and-loop fastener member disposed on the outer surface of the wrap;
wherein the second connecting component is a second hook-and-loop fastener member disposed on the exterior side of the host machine; and
wherein the first hook-and-loop fastener member and the second hook-and-loop fastener member provide reversible adhesive connection and separation through engagement of hooks and loops.

4. The detachable pneumatic therapeutic apparatus according to claim 1, wherein the first connecting component is a first engagement member disposed on an outer surface of the wrap;
wherein the second connecting component is a second engagement member disposed on an exterior side of the host machine; and
wherein the first engagement member and the second engagement member provide reversible connection and separation by means of a snap-fit or plug-and-socket engagement.

5. The detachable pneumatic therapeutic apparatus according to claim 1, wherein the first connecting component is a first magnetic member disposed on the outer surface of the wrap;
wherein the second connecting component is a second magnetic member disposed on the exterior side of the host machine; and
wherein the first magnetic member and the second magnetic member provide reversible connection and separation through magnetic attraction.

6. The detachable pneumatic therapeutic apparatus according to claim 1, wherein the second connecting component is fixed to the exterior side of the host machine via a fixing assembly, and wherein the fixing assembly is detachably connected to the host machine.

7. The detachable pneumatic therapeutic apparatus according to claim 6, wherein the fixing assembly comprises a fixed frame and a connecting member, the fixed frame surrounds a bottom perimeter of the second connecting component;
the connecting member sequentially passes through the fixed frame, the second connecting component, and the host machine, to secure the second connecting component between the host machine and the fixed frame; or
the connecting member sequentially passes through the host machine, the second connecting component, and the fixed frame to secure the second connecting component between the host machine and the fixed frame.

8. The detachable pneumatic therapeutic apparatus according to claim 1, wherein the one or more air bags are in communication with an inflation/deflation module inside the host machine through the pipeline component;
wherein the pipeline component comprises a first connector disposed on the one or more air bags and a second connector disposed on the host machine; and
wherein the first connector and the second connector are detachably mated to establish a pneumatic connection between the inflation/deflation module and the one or more air bags.

9. The detachable pneumatic therapeutic apparatus according to claim 8, wherein the pipeline component further comprises:
a first air flow tubing, one end of which is connected to an air pressure nozzle of the one or more air bags, and the other end of which is connected to the first connector; and
a second air flow tubing, disposed inside the host machine, one end of which is connected to the inflation/deflation module, and the other end of which is connected to the second connector, wherein the second connector is disposed on an exterior side of the host machine.

10. The detachable pneumatic therapeutic apparatus according to claim 9, wherein the inflation/deflation module comprises:
an air pump, connected via the second air flow tubing to the one or more air bags for providing an inflation airflow;
a first electromagnetic valve connected to the second air flow tubing for releasing airflow; and
a pressure relief valve, connected to the second air flow tubing,
wherein the inflation and deflation modes for the one or more air bags are switched by controlling the opening and closing of the air pump and the first electromagnetic valve, and wherein the pressure relief valve is configured to open for pressure relief when a pressure in a pneumatic circuit exceeds a set threshold.

11. The detachable pneumatic therapeutic apparatus according to claim 10, wherein the host machine further comprises a control panel disposed inside the host machine, and both the air pump and the first electromagnetic valve are electrically connected to the control panel;
wherein a pressure sensor is integrated on the control panel; and
wherein the pipeline component further comprises a third air flow tubing, the pressure sensor being in communication with the second air flow tubing via the third air flow tubing.

12. The detachable pneumatic therapeutic apparatus according to claim 11, wherein the host machine further comprises one or more batteries electrically connected to the control panel, wherein the one or more batteries are rechargeable or disposable.

13. The detachable pneumatic therapeutic apparatus according to claim 1, wherein the surface of the host machine in contact with the second connecting component is configured as an arcuate contact surface having a predefined curvature such that the host machine conforms to a treatment area.

14. The detachable pneumatic therapeutic apparatus according to claim 1, wherein the wrap is provided with a releasably mateable and adjustable fastener such that the wrap can be worn on a treatment area.

15. The detachable pneumatic therapeutic apparatus according to claim 1, wherein the wrap further comprises a heating component disposed therein;
wherein the host machine is provided with conductive contact plates, and the wrap is provided with conductive contacts; and
wherein the heating component is electrically connected to the host machine through the conductive contacts and the conductive contact plates.

16. The detachable pneumatic therapeutic apparatus according to claim 1, wherein the wrap further comprises a cooling component disposed therein;
wherein the host machine is provided with conductive contact plates, and the wrap is provided with conductive contacts; and
wherein the cooling component is electrically connected to the host machine through the conductive contacts and the conductive contact plates.

17. The detachable pneumatic therapeutic apparatus according to claim 16, wherein the cooling component comprises a fan and a cooling plate, and wherein the fan is electrically connected to the host machine and is configured to dissipate heat from the cooling plate.

18. The detachable pneumatic therapeutic apparatus according to claim 1, further comprising:
a first verification module disposed on the wrap, and a second verification module disposed on the host machine;
wherein after the host machine is connected to the wrap, the first verification module and the second verification module perform verification matching; and
wherein the host machine controls an operational state of the host machine based on a verification matching result.

19. An assembly and disassembly method for a detachable pneumatic therapeutic apparatus, comprising:
aligning a second connecting component on a host machine with a first connecting component on a wrap;
applying an external force to cause the first connecting component and the second connecting component to be detachably connected in a reversible manner to provide connection between the host machine and the wrap; and
connecting the host machine to one or more air bags within the wrap through a pipeline component, enabling the host machine to control inflation and deflation of the one or more air bags.

20. The assembly and disassembly method for a detachable pneumatic therapeutic apparatus according to claim 19, further comprising:
applying a pulling force in a direction perpendicular to the contact surface between the first connecting component and the second connecting component to separate the first connecting component from the second connecting component to detach the host machine from the wrap; and
disconnecting the pipeline component connected between the host machine and the wrap to complete separation of a pneumatic circuit.
